(19) United States
(12) Patent Application Publication
(10) Pub. No.: US 2002/0061382 A1
(43) Pub. Date: May 23, 2002

(54) Coating of optical discs for a waterproof print surface

(76) Inventor: Mark D. Strobel, Orono, MN (US)

Correspondence Address: Nickolas E. Westman, WESTMAN CHAMPLIN & KELLY, International Centre, Suite 1600, 900 South Second Avenue, Minneapolis, MN, 55402-3319, US

(21) Appl. No.: 09/990,652

(22) Filed: Nov. 20, 2001

Related U.S. Application Data
(60) Provisional application No. 60/249,941, filed on Nov. 20, 2000.

(51) Int. Cl. B32B 3/02

(52) U.S. Cl. 428/64.4; 428/64.1

(57) ABSTRACT

An optical disc is plastic and has a printable or ink receptive first layer on which ink printing can take place. It is then coated with a material that covers the printable layer such that when ink jet printing is printed on the outer layer, the ink will pass into and be retained by the ink receptive layer. The outer layer inhibits outward diffusion of the ink when in the presence of moisture so the printer will not be affected by water on the surface of the disc.

### CROSS REFERENCE TO RELATED APPLICATION

The present application is based on and claims the benefit of U.S. provisional patent application Ser. No. 60/249,941, filed Nov. 20, 2000, the content of which is hereby incorporated by reference in its entirety.

### BACKGROUND OF THE INVENTION

The present invention relates to coating of an optical disc in order to make the printable surface of the optical disc waterproof, to avoid smearing, smudging or wearing off of the printed matter. The coating is provided as a layer on the surface of a compact disc (CD) or digital video disc (DVD) or other optical disc on top of the normal ink receiving layer on the disc, the disc surface becomes waterproof.

Printing on the surfaces of plastic optical discs is known, and usually the discs are coated with a layer of ink receiving material since the underlying mylar or other plastics will not permit ink to adhere. The printable surface, however, is not waterproof, so if the disc gets wet or damp, the printable surface material will absorb water and the surface water will cause the ink to smear, smudge or wear off more easily.

The appearance of the disc is greatly affected if the ink smears or if runs. Also, wearing off of the printing in a premature fashion is objectionable.

An optical disc such as a CD, DVD, recordable DVD, recordable CD, or other optical disc (called a disc) is commonly provided with a ink receiving layer on top of the disc so that printers can print an image directly on top of the disc. This is done in the present invention in a normal manner. The disc has ink receiving layer added to its surface.

The present invention includes additionally coating the surface of the print receptive layer with a material that forms a porous outer coating which allows the ink to be absorbed into the printable layer or ink receptive layer, but which porous outer coating restricts diffusion of the ink from the receptive surface when exposed to moisture, that will saturate the printable surface. The porous outer coating will overly the printing so that water does not cause the printing ink to run or smear. Colorants are locked into place, on or in the printable surface layer.

The extra outer layer protects the image from the ill effects caused by moisture, allowing the CD's, DVD's or other discs to be used in a variety of applications without fear of ruining the printed image.

Paper that has been coated with material that will take ink jet printing and will make it waterproof is sold by Kimberly Clark, in sheets, under the trademark EPIC. In addition to papers, films and fabrics that have been treated with the coating and sold under this name, signs and banners materials.

U.S. Pat. No. 4,877,678 disclosed material for coating a substrate or sheet (such as a plastic) with an ink receptive layer, and an outer porous coating. The coating materials disclosed therein are suitable for the present invention.

### BRIEF DESCRIPTION OF THE DRAWINGS

FIG. 1 is a plan view of a typical round optical disc on which a coating of the present invention is placed;

FIG. 2 is a sectional view through the center of the disc shown in FIG. 1; and

FIG. 3 is a modified outer shape of the disc that would have the same cross sectional configuration as that shown in FIG. 2.

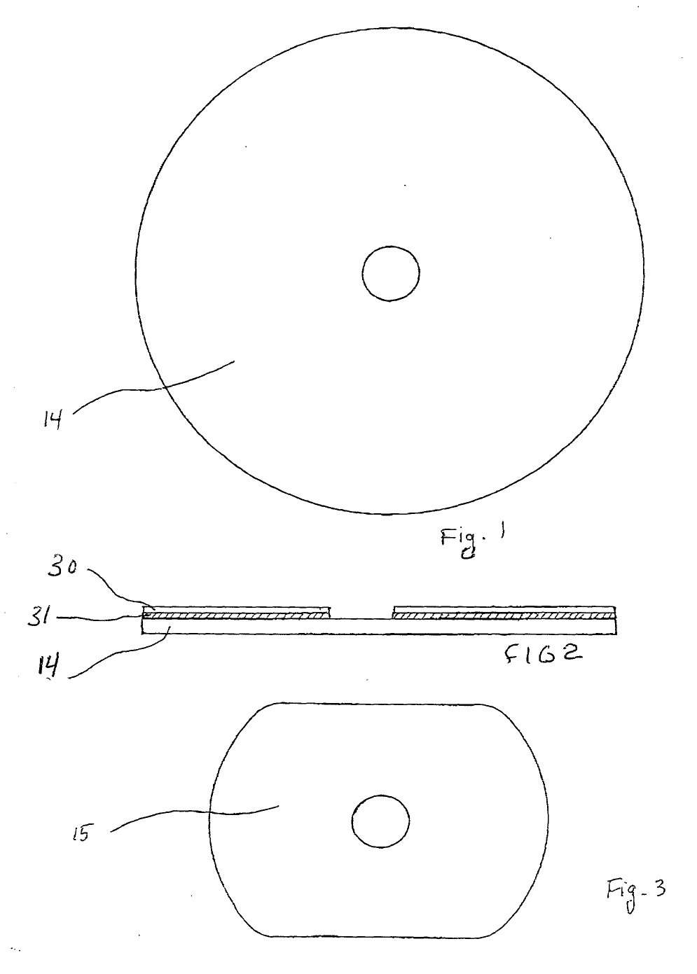

### DETAILED DESCRIPTION OF THE ILLUSTRATIVE EMBODIMENTS

In the drawings a round disc 14, as shown, is a CD, DVD, recordable CD recordable DVD or optical disc of suitable configuration. This is a disc on which printing is to be placed, as is known. As shown in FIG. 2, a layer 31 of an ink receiving or ink receptive material is placed on the disc 14 surface in a normal manner. This ink receptive layer 31 can be material presently used on discs for providing a printable surface. A porous outer layer 30 of which is for example a uniform dispersion of an inorganic water-absorbative powder in an organic polymer as a binder is applied over the print receptive layer 31. This material is disclosed in detail in U.S. Pat. No. 4,877,678. The disclosure of which is incorporated by reference for both the print receptive and outer layer material.

The outer layer 30 also can be the same material as the material used on the Kimberly Clark printable materials sold under the trademark EPIC.

The layer 30 would be applied in place over the layer 31. Layer 30 may migrate slightly into the printable layer 31 for adherence. The surface of layer 30 that is exposed to the printer retains its ability to absorb the normal aqueous based dye and pigmented inks used with wide format ink jet printers.

Because the disc 14 now is constructed in a manner that includes the material layer 30 and the ink receptive layer 31, it will absorb the ink, but the outer layer 30 prevents the ink from migrating out or smearing. The printed message on the disc becomes essentially waterproof so that the ink in the layer is not susceptible to being smeared, or to run easily when it becomes damp or wet. The layer 30 of material can be sprayed on, or applied in other ways.

Coating an ink-jet receptive surface with a porous outer coating 30 allows the printed ink to diffuse through the outer coating where the ink is absorbed in, or on, the receptive surface and restrict diffusion of the ink from the receptive surface when exposed to moisture.

The outer coating layer 30 includes a solid filler to create porosity and to control diffusion of the liquid ink through the coating, into the base or print receptive surface. These compounds may be selected from the group consisting of silica, clay, talc, calcium carbonate, calcium sulfate, titanium dioxide, aluminum silicate, calcium silicate, magnesium silicate and aluminum hydroxide.

The key is that once the ink is absorbed into the base or ink receptive coating layer 31, the top coating 30 is less absorbent, and restricts further absorption of moisture and diffusion of the ink from the printed surface, thereby protecting the printed image. The organic polymer in the outer coating 30 may be from the group consisting of poly vinyl acetate, copolymers of ethylene and vinyl acetate, saturated polyester resins, polyurethanes, polyamides, epoxy resins, phenolic resins, unsaturated polyester resins, acrylic resins, polyisocyanate resins, polychloroprene rubbers, nitrile rubbers, styrenebutadiene copolymeric rubbers, silicone rubbers, nature rubber, oxidized starch, etherified starch, esterfied starch, carboxymethyl cellulose, methyl cellulose, ethyl cellulose, hydroxyethyl cellose, casein, gelatin and polyvinyl alcohol. These compounds are disclosed in U.S. Pat. No. 4,877,678. This topcoat is more hydrophobic, and tends to inhibit migration of dissolved ink from the printed surface to the environment.

Other compounds also can be used. The desired result is porosity to let the ink pass through the outer layer to the ink receptive layer and inhibit outward migration of the ink when the ink receptive layer gets wet.

In FIG. 3, a modified shape disc 15 is shown. This would be treated in the same way as described for printing.

Although the present invention has been described with reference to preferred embodiments, workers skilled in the art will recognize that changes may be made in form and detail without departing from the spirit and scope of the invention.

What is claimed is:

1. An optical disc having a first layer of ink receptive material thereon for receiving ink jet printing, and a second layer applied to the first layer which permits ink to pass into the ink receptive layer but inhibits diffusion of the ink from the first layer when the disc is exposed to moisture.

2. The optical disc of claim 1 wherein the second layer is a water-absorbative inorganic powder mixed with and dispersed into an organic polymer as a binder.

3. An optical disc comprising a plastic disc, a first layer of ink receptive material on a surface of the disc, and a second overlying layer of material on the first layer, the second overlying layer being porous to permit ink to be printed into the first layer and restricting outward diffusion of the ink from the first layer in the presence of moisture.

4. The optical disc of claim 3 wherein the optical disc is one of a CD, a DVD, a recordable CD and a recordable DVD.
